(19) United States
(12) Patent Application Publication
(10) Pub. No.: US 2026/0340096 A1
(43) Pub. Date: Oct. 29, 2026

(54) System and Method for User-Initiated Removal of Synthetic and Unauthorized Digital Likeness via AI-Based Biometric Verification

(71) Applicant: Kate Elspeth Steinmeyer, East Palo Alto, CA (US)

(72) Inventor: Kate Elspeth Steinmeyer, East Palo Alto, CA (US)

(21) Appl. No.: 19/188,939

(22) Filed: Apr. 24, 2025

(51) Int. Cl. G06F 21/32; G06F 21/10; G06V 10/62; G06V 10/74; G06V 10/77; G06V 10/776; G06V 10/82; G06V 30/19; G06V 40/16; G06V 40/20; G06V 40/70

(52) U.S. Cl. CPC G06F 21/32; G06F 21/1063; G06V 10/62; G06V 10/761; G06V 10/7715; G06V 10/776; G06V 10/82; G06V 30/1916; G06V 40/171; G06V 40/20; G06V 40/70

(57) ABSTRACT

A system and method enabling users to initiate the detection and removal of unauthorized digital likenesses from multimedia content using real-time biometric and identity verification. Upon submitting a takedown request, a user provides a live facial video and/or voice sample, along with a valid government-issued ID. The system verifies the user's identity and compares the provided biometric data against the reported content using AI-based facial and voice similarity algorithms. If the similarity score exceeds a predetermined threshold, the content is removed from the platform. The original content uploader may submit a counterclaim by performing their own biometric scan and ID submission, triggering a secondary evaluation. The system supports 2D video, GIFs, audio, 3D avatars, and virtual or augmented reality representations, and includes a moderation fallback mechanism for borderline similarity scores.

### FIELD OF THE INVENTION

The invention relates to systems and methods for detecting and removing unauthorized use of an individual's digital likeness in multimedia content. Such content may include AI-generated or manipulated media such as videos, audio recordings, avatars, or simulations. More specifically, the invention provides a user-initiated takedown and counterclaim system that leverages real-time biometric verification, government-issued ID validation, and AI-based similarity scoring across multiple modalities, including a live biometric scan that captures facial, body, and vocal input.

### BACKGROUND

As synthetic media generation technologies advance, including AI-based audio synthesis and facial animation, users increasingly face the risk of impersonation, identity misuse, and unauthorized digital representations. Traditional content flagging and reporting tools are often manual, lack biometric validation, and provide limited recourse for individuals whose likeness has been misused.

The invention addresses this problem by enabling individuals to submit takedown requests for suspected unauthorized digital likenesses. The user is prompted to complete a live biometric scan—including both facial and vocal input—and to submit a valid government-issued identification. The system then uses AI-based comparison models to evaluate the similarity between the user's biometric data and the reported content. If the similarity score in either modality exceeds a defined threshold, the content is automatically removed. The original content uploader is provided with an opportunity to challenge the takedown by submitting their own biometric scan and ID, initiating a re-evaluation process to determine final content status.

### Key Components

User Report Interface: Allows selection of suspect content and initiates biometric scan and ID upload.

Biometric Capture Module: Requires live capture through camera and microphone.

ID Verification System: Uses OCR and validation logic for document checks.

AI Comparison Engine: Compares reported content to biometrics and outputs a match score.

Takedown Trigger: Removes content automatically if above the threshold.

Counterclaim Module: Enables the original content uploader to contest a takedown using real-time biometric data and valid government-issued ID. If the uploader is a business entity or brand, they must also submit supporting documents demonstrating a valid agreement, such as a signed contract, appearance release, or promotional consent form. These documents are made available to the reporting party for review, enabling them to take legal action if the provided materials are falsified or misused.

Audit & Moderation Layer: Fallback moderation for borderline scores.

### Use Cases

A video-sharing platform user discovers a deepfake of themselves and submits a takedown request using live biometric verification and ID.

A person encounters a digital avatar in a virtual reality environment—such as a workplace simulation, social VR platform, or training app—that mimics their appearance or voice without consent and reports it.

A social media influencer finds a deepfake video circulating online that falsely depicts them participating in a podcast they were never on, using footage from a different interview and AI-generated audio to change what they appear to be saying. They submit a takedown request using the system.

A social media video features a deepfake of a public figure, private individual or influencer promoting a product or brand they have never used or endorsed. The impersonated individual uses the system to verify their identity and request the content's removal.

A private individual notices that a manipulated video of them has been shared in a group chat and reposted on social media, falsely showing them saying inappropriate or offensive content. They use the system to verify their identity with a live scan and ID, and request the takedown.

### Fallback & Dispute Logic

If similarity scores fall within a range (e.g., 60-80%), content is sent for manual review. All biometric data is encrypted and deleted after processing. Appeals are limited to a fixed time window and require dual verification (biometrics+ID).

### Optional Enhancements

The system may optionally include:
Integration with facial motion detection for GIFs: Enhances deepfake detection by analyzing frame-to-frame facial movements, enabling the system to detect AI-manipulated expressions or mismatched lip-sync in looping animated formats such as GIFs.
Use of blockchain for takedown audit trails: Maintains a tamper-proof log of all takedown and counterclaim actions, including submission timestamps, match scores, user IDs (hashed), and outcome records. This provides immutable evidence of system activity for legal or compliance review.
Visual confirmation preview before takedown completes: Allows the reporting user to view a side-by-side comparison of the submitted biometric scan and the suspected content before finalizing the takedown request. This reduces false positives and improves user trust in the system.

In certain embodiments, the system described herein incorporates safeguards to ensure user privacy, security, and legal compliance. All biometric scans and identification uploads are initiated by the user and require explicit, informed consent before data is collected or processed. The system does not perform passive or unauthorized surveillance.

Biometric data and government-issued identification documents are encrypted upon capture, used exclusively for the identity verification and content matching steps described herein, and are deleted after the verification process is completed. No biometric or identification data is shared with third-party services or stored beyond the minimum time required for comparison.

The system may optionally log the takedown and counterclaim events in a secure, immutable audit trail using blockchain or similar technology, but no personally identifiable information is included in such logs unless required by platform policy or legal investigation.

In some embodiments, the system supports multi-device biometric capture. A user may pair a secondary device, such as a mobile phone, with the primary reporting device via a secure interface (e.g., QR code, link token, or Bluetooth proximity). The system then distributes the biometric input tasks, capturing facial and body video through a desktop camera, while collecting voice or ambient sound input from the mobile microphone. These data streams are time-synchronized and jointly analyzed to increase detection accuracy, reduce spoofing risks, and verify liveness across modalities and devices.

### BRIEF DESCRIPTION OF THE DRAWINGS

FIG. 1 illustrates the system architecture of a biometric-based reporting and content takedown system, including the flow from user report submission through AI similarity evaluation, decision-making, optional blockchain logging, and counterclaim processing.

FIG. 2 illustrates the step-by-step user workflow for submitting a takedown request within the system, including live biometric capture, ID verification, similarity feedback, and final request submission.

FIG. 3 illustrates the decision logic of the AI similarity engine, showing how similarity scores determine whether content is removed, flagged for moderation, or ignored, and how those outcomes are optionally logged for auditing.

FIG. 4 illustrates the counterclaim process available to content uploaders whose media has been removed. The uploader may challenge the takedown by submitting real-time biometric data and identification, which the system uses to re-evaluate the match and determine final content status.

FIG. 5 illustrates the optional blockchain-based audit trail used to log and timestamp key events during the content takedown and counterclaim process. The figure presents a linear timeline of events, each associated with a corresponding blockchain hash, ensuring immutability and transparency of the reporting workflow.

FIG. 6 illustrates the motion analysis module for detecting deepfake content in GIF animations. The system extracts facial and body keypoints from each frame, analyzing motion patterns such as lip-sync, blinking, and body posture for anomalies that suggest manipulated or AI-generated content.

FIG. 7 illustrates a user interface for initiating a takedown request, including content submission, ID upload, and setup for real-time facial/body and voice biometric scanning.

FIG. 8 illustrates the biometric scanning process and real-time similarity evaluation between the user's input and the reported content.

FIG. 9 illustrates the final confirmation interface, where the user reviews their results and submits the takedown request.

FIG. 10 illustrates a multi-device biometric capture interface in which a user submits facial/body and voice data from two separate devices for identity matching.

### DETAILED DESCRIPTION

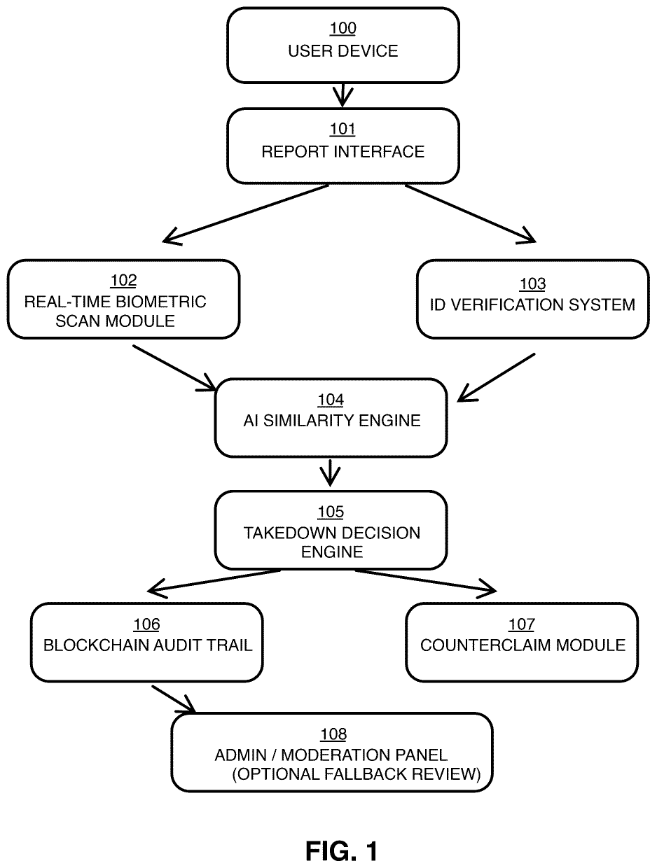

FIG. 1, in one embodiment, the system shows an overview of the primary components involved in identifying and removing unauthorized digital likenesses.

A user device (100) initiates the process by connecting to the report interface (101), which serves as the entry point for users to submit content suspected of containing their unauthorized likeness.

The user is prompted to perform a biometric scan via the real-time biometric scan module (102), which captures live video and/or voice input in real time. Simultaneously or sequentially, the user must upload a valid government-issued ID to the ID verification system (103), which authenticates the document using OCR and image validation technology.

Both the real-time biometric data and the validated ID are passed to the AI similarity engine (104), which compares the user's biometric features to the reported content using facial and voice recognition algorithms. A similarity score is generated.

The score is evaluated by the takedown decision engine (105). If the score exceeds a defined threshold, the content is flagged for removal. If the score falls within a borderline range, the case may be escalated to the admin/moderation panel (106) for manual review.

All actions, decisions, and timestamps can optionally be recorded in the blockchain audit trail (107) to ensure transparency and non-repudiation.

In cases where content is removed, the original content uploader may engage the counterclaim module (108), where they are prompted to complete their own biometric scan and ID upload. Their input is also analyzed by the AI similarity engine to determine whether the content should be reinstated or remain removed.

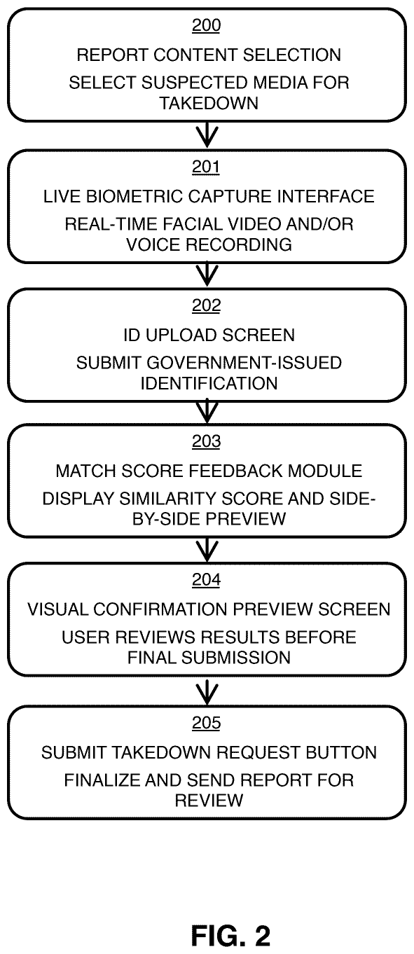

FIG. 2, in one embodiment, the system shows the user-side interaction flow that enables individuals to report unauthorized digital likenesses through a structured takedown interface.

The user begins by selecting the content in question using a report content selection screen (200), where they can specify the media (e.g., video, GIF, avatar, etc.) and the platform or source.

Next, the system launches the live biometric capture interface (201), prompting the user to record a real-time video of their face and/or a voice sample. The system ensures the input is captured live, not uploaded, and is validated for liveness and clarity.

The user is then directed to the ID upload screen (202), where they must submit a valid government-issued identification document. This document is authenticated via the system's OCR and image validation layer before proceeding.

Once both biometric and ID data are submitted, the user is shown a match score feedback module (203). This module provides a visual preview of the similarity score between the user's biometric input and the reported content. If available, the system also displays a side-by-side image or waveform comparison for transparency.

Before submitting the request, the user is given the opportunity to review their inputs and the system's findings via the visual confirmation preview screen (204). If satisfied, they confirm the report by clicking the submit takedown request button (205).

The submitted request is then processed by the core system as described in FIG. 1, proceeding to AI-based evaluation and potential removal of the flagged content.

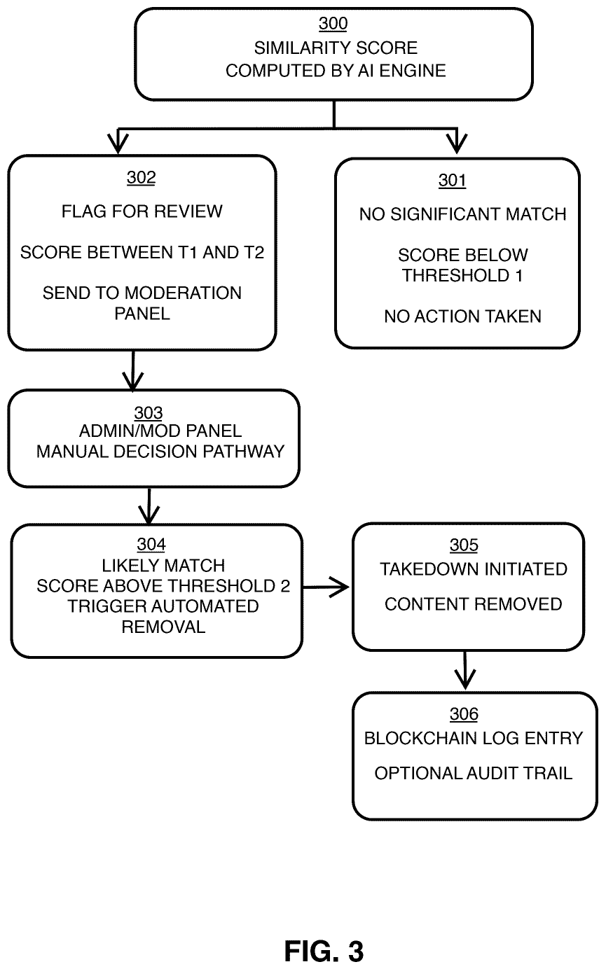

FIG. 3, in one embodiment, presents the decision-making process following biometric comparison. The system begins by calculating a similarity score (300) using AI-driven facial and voice recognition algorithms.

If the score falls below a lower threshold (T1), the system classifies the result as no significant match (301) and no action is taken.

If the score lies between threshold T1 and a higher threshold T2, the content is flagged for review (302). These cases are sent to the admin/moderation panel (303), where a human reviewer performs a manual evaluation.

When the similarity score exceeds threshold T2, the system categorizes the content as a likely match (304) and proceeds to trigger automated removal (305).

After content is removed, the action is logged through a blockchain log entry (306). This optional audit trail includes the match score, timestamps, and the takedown decision to ensure transparency and support future legal or administrative review.

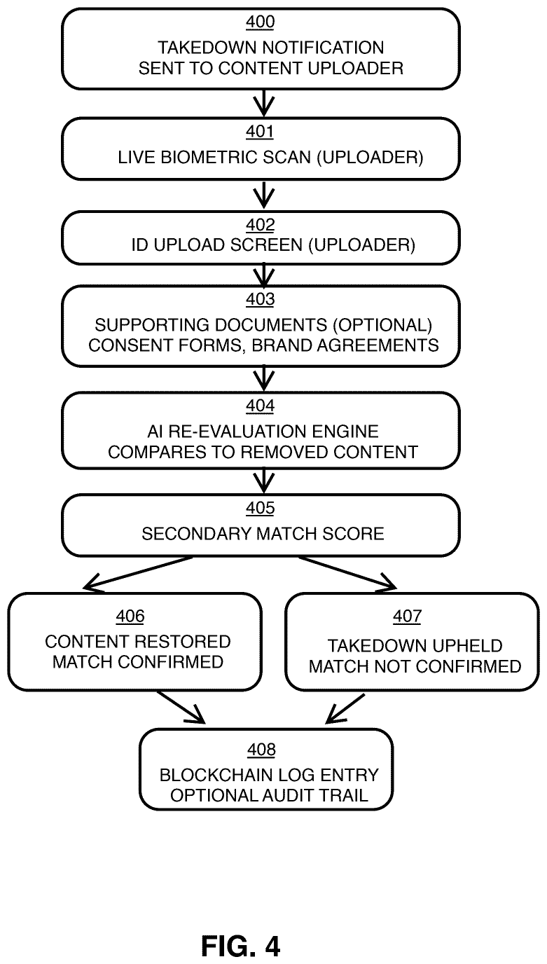

FIG. 4, in one embodiment, depicts the flow initiated when an original content uploader submits a counterclaim following a takedown.

Upon content removal, the uploader receives a takedown notification (400) with the option to challenge the action. To proceed, the uploader must perform a real-time biometric scan (401) and submit a valid government-issued ID (402). If the uploader is a business entity or brand, they must also upload supporting legal documentation (403), such as an appearance release or endorsement agreement.

The system then runs a second comparison through the AI similarity engine (404), evaluating the uploader's biometric data against the removed content.

The system computes a secondary match score (405). If the content appears to accurately depict the uploader, the system may restore the content (406). If not, the removal remains in effect.

All steps and evidence—both from the original report and the counterclaim—are optionally logged to the blockchain audit trail (407) for transparency, legal accountability, and reference in the event of dispute escalation.

An additional blockchain log entry (408) is generated to record the final takedown outcome. This entry may include metadata such as timestamps, uploader verification status, similarity scores, and restoration or rejection decisions. These logs ensure that the resolution of disputed content is traceable and tamper-proof, forming part of the system's optional audit trail infrastructure.

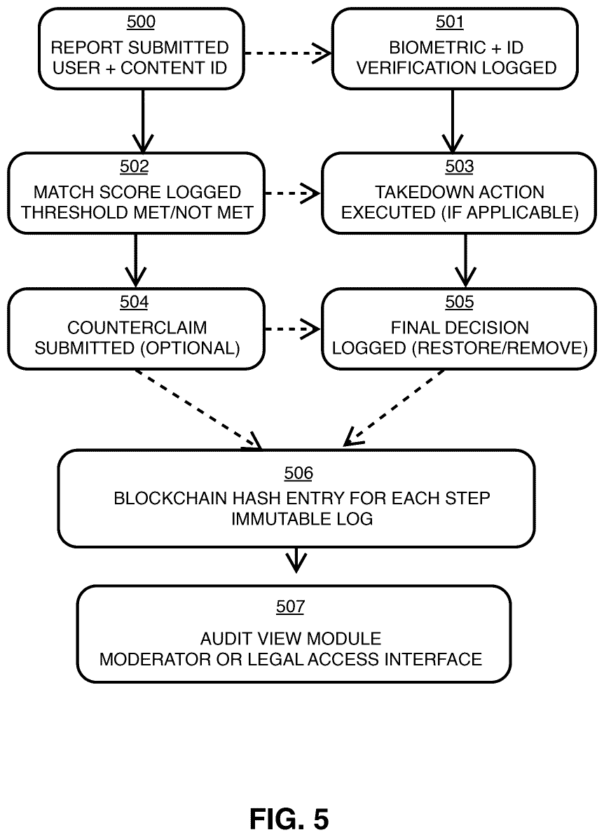

FIG. 5, in one embodiment, presents a linear event log that demonstrates how the system optionally stores major actions in a blockchain-based ledger to ensure traceability and integrity.

The timeline begins with the report submission event (500), which includes metadata such as user ID (hashed), reported content ID, and timestamp. Next, the system logs the biometric scan and ID verification (501), which confirms the user's identity before proceeding.

Once verified, the system records the AI match score and threshold evaluation (502), storing the computed similarity score and whether it met predefined thresholds. If the content is removed, a takedown execution entry (503) is logged.

If the original uploader responds with a counterclaim, the system logs the counterclaim submission (504) and, following a second biometric comparison, the final resolution (505)—either reinstating or upholding the removal.

Each entry in the log is tied to a unique blockchain hash (506), which cryptographically secures the data and allows independent validation of the audit trail. A viewer module (507) allows internal moderators or legal reviewers to view the full audit sequence.

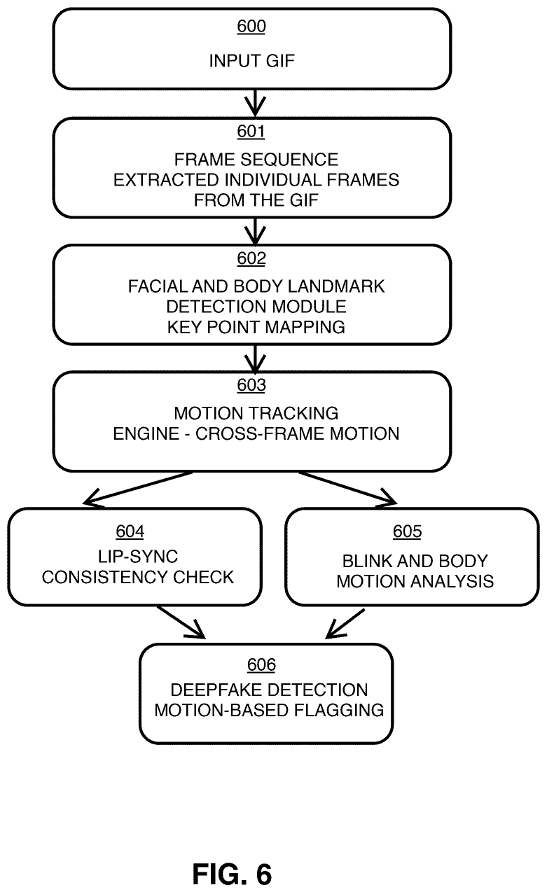

FIG. 6 in one embodiment, presents the frame-by-frame processing logic used to detect AI-generated manipulations in GIFs through facial and body motion analysis.

The workflow begins with an input GIF (600), which is split into a frame sequence (601). Each frame is processed by a facial and body landmark detection module (602), which identifies key facial features (e.g., eyes, ears, lips, jawline) as well as body posture markers (e.g., shoulders, arms, hands, spine alignment).

This data is passed to a motion tracking engine (603), which analyzes the movement of these landmarks across consecutive frames. The system evaluates both lip-sync consistency (604) and blink timing (605), and may also assess full-body motion for unrealistic or AI-generated patterns.

If irregularities such as jittery posture, unnatural expressions, or desynchronized audio cues are detected, the system flags the media as a likely manipulated GIF (606).

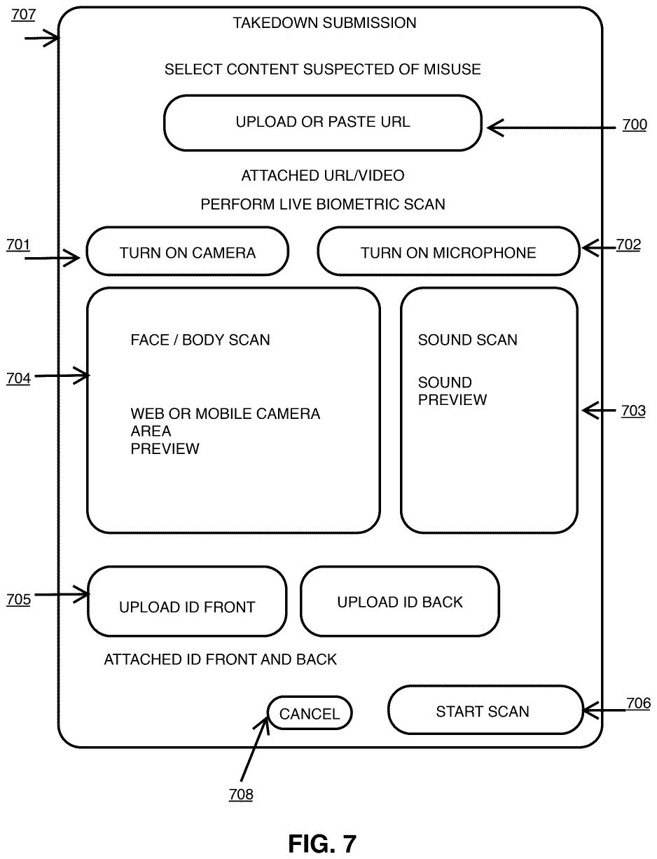

FIG. 7, in one embodiment, presents the user interface used to initiate a takedown submission. The user may either upload a video file or paste a URL referencing the suspected content (700).

The interface prompts the user to upload images of a government-issued ID, including both front and back sides (705), which are then validated by the system. Concurrently, the user is guided to activate their device's camera and microphone (704, 703) in preparation for a real-time biometric scan.

The camera preview area (704) displays a live video feed capturing the user's facial and/or body features, while the microphone preview (703) may show an audio waveform or level meter in real time. The system requires the user to submit both a facial/body scan and a voice sample for authentication, regardless of whether the reported content includes only video, only audio, or both. However, during similarity evaluation, the system processes each biometric modality independently—a match in either facial/body or voice data may be sufficient to trigger a takedown action.

Once the user is ready, a “Start Scan” button (706) initiates the biometric capture process. A “Cancel” button (708) is available to exit or reset the submission flow at any time.

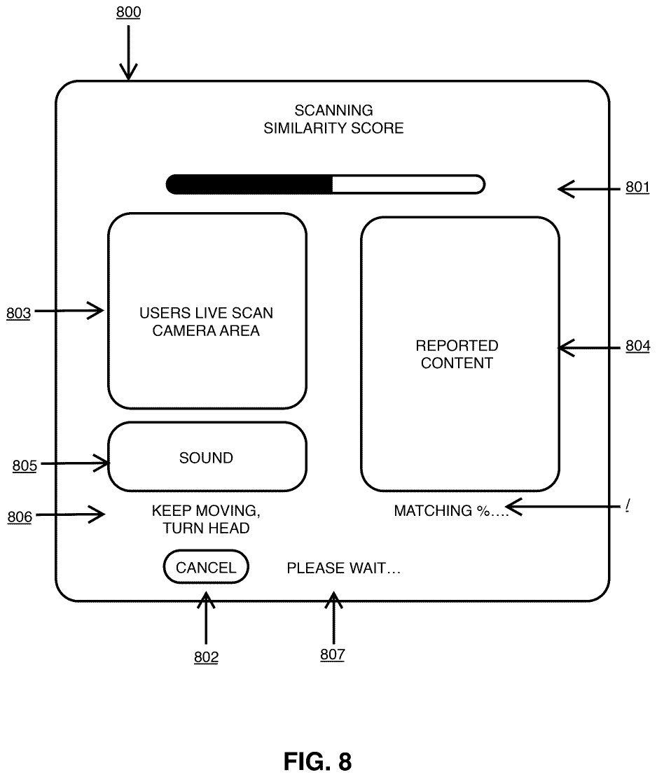

FIG. 8, depicts the real-time biometric scanning and similarity evaluation user interface. At the top of the interface (800), system feedback such as “Scanning” is displayed to indicate that biometric data is actively being processed. A progress bar (801) shows how close the user is to completing the scan.

A camera module (803) captures the user's face and/or body, and includes on-screen prompts instructing the user to maintain liveness, such as turning their head or moving naturally (806). Simultaneously, the system captures voice input through a microphone, with visual audio feedback displayed in the preview area (804).

Once biometric data is collected, the system compares it to the reported content using AI-driven similarity algorithms. A similarity score (805) is generated and displayed in real time as a percentage match. The interface includes a status message such as “Please wait . . . ” (807) and a Cancel button (802) that allows the user to interrupt or exit the scanning process.

This figure reinforces the requirement that both facial and vocal biometric inputs be submitted for analysis, regardless of whether the reported content includes only video, only audio, or both. However, the system is configured such that a match in either modality—facial or vocal—may independently satisfy the similarity threshold for initiating a takedown.

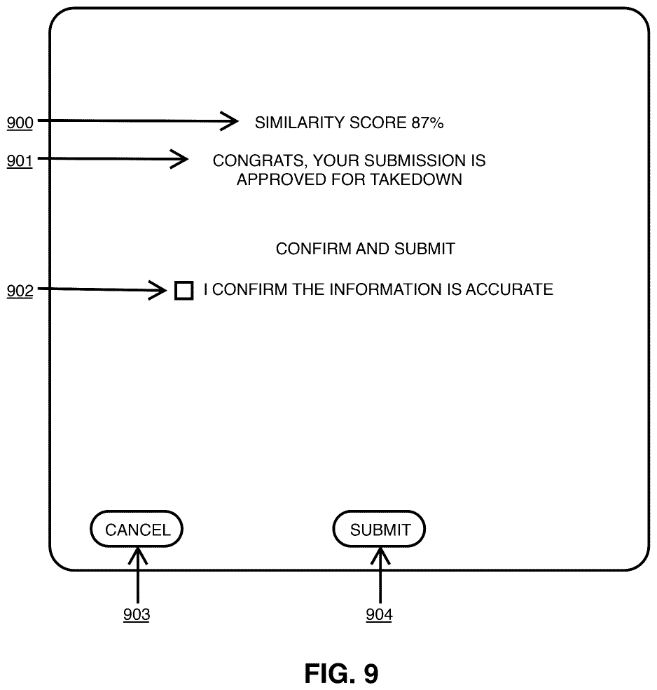

FIG. 9 shows the confirmation screen presented after biometric processing is complete. A similarity score (900) is prominently displayed, with contextual messaging such as “Your submission is approved for takedown” (901) based on threshold criteria. The user is prompted to confirm the accuracy of the information provided (902) via a legal attestation checkbox. The interface includes “Cancel” and “Submit” buttons (903, 904) allowing the user to finalize or withdraw their request. This screen concludes the takedown flow and initiates the system's backend review or automated removal actions. The system logs this event and transitions to either notify the platform or proceed to counterclaim handling, if applicable.

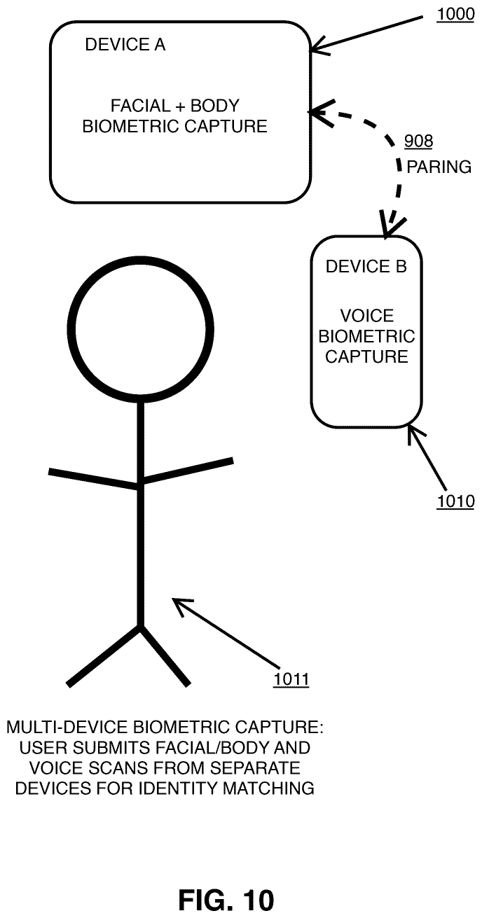

FIG. 10, in one embodiment, illustrates a multi-device biometric capture process. Device A (1000) captures the user's facial and body data through a live camera interface labeled as “facial +body biometric capture.” Device B (1010) simultaneously captures the user's voice through a microphone interface labeled as “voice biometric capture” (1011). A pairing process (908) links the two devices, allowing the system to synchronize the biometric inputs from both sources. This configuration enables enhanced verification by separating the facial/body and vocal capture processes across two devices. The collected biometric data is then used for AI-based similarity scoring against reported content.

1. A method for identifying and removing unauthorized digital likenesses from a digital platform, comprising receiving a user-submitted report of content suspected to depict the user's likeness, prompting the reporting user to perform a real-time biometric scan comprising at least one of a live video capture and a live voice sample recorded through the system interface, requiring the reporting user to upload a valid form of government-issued identification, verifying the authenticity of the identification and associating it with the biometric data, comparing the real-time biometric scan to the reported content using an AI-based similarity engine, generating a similarity score, initiating removal of the reported content if the similarity score exceeds a predefined threshold, and providing an optional counterclaim process for the original content uploader, requiring submission of a live biometric scan and valid identification to challenge the takedown.

2. The method of claim 1, wherein the reported content includes at least one of: a video file, a GIF, a 3D avatar, a virtual reality simulation, or an audio recording.

3. The method of claim 1, wherein the real-time biometric scan includes both live facial video and live voice audio, captured directly from the user at the time of reporting.

4. The method of claim 1, further comprising notifying the content host or platform administrator upon content takedown.

5. The method of claim 1, wherein the similarity threshold is dynamically adjusted based on the type of content or platform.

6. The method of claim 1, further comprising allowing the user to view the similarity score prior to final submission of the takedown request.

7. The method of claim 1, wherein a fallback moderation mechanism is activated if the similarity score falls within a defined borderline range.

8. The method of claim 1, wherein the biometric data is encrypted and stored temporarily for verification only, and then deleted.

9. The method of claim 1, wherein the government-issued identification is validated using optical character recognition and image verification technologies.

10. The method of claim 1, wherein the content uploader is notified of the takedown and provided the option to submit a counterclaim within a defined time period.

11. The method of claim 10, wherein the counterclaim must include a real-time biometric scan and a valid government-issued identification document from the content uploader.

12. The method of claim 11, wherein the system compares the uploader's biometric scan to the content in question, and either restores or permanently removes the content based on the similarity threshold and ID verification.

13. The method of claim 1, further comprising analyzing frame-by-frame motion of facial and body landmarks within an animated media file, including but not limited to Graphics Interchange Format (GIF) files, to detect inconsistencies in expression, posture, or movement indicative of synthetic or manipulated content.

14. The method of claim 1, wherein the system is applied in a virtual reality or metaverse platform to detect unauthorized use of a user's likeness in avatars, simulations, or immersive 3D environments.

15. The method of claim 1, further comprising logging reporting, biometric, and takedown events in a blockchain-based audit trail, wherein each log entry includes a timestamp, user identifier, content identifier, and action outcome.

16. The method of claim 11, wherein the content uploader is a business entity or organization, and the counterclaim further requires submission of supporting documentation demonstrating legal authorization to use the depicted likeness, including but not limited to appearance releases, promotional agreements, or signed contracts.

17. The method of claim 1, wherein the system is used by influencer platforms or brand endorsement marketplaces to detect and remove unauthorized promotional content that falsely attributes an endorsement to the reporting user.

18. The method of claim 1, wherein comparing the real-time biometric scan to the reported content comprises extracting facial and/or voice feature embeddings from both the scan and the reported media, and computing a similarity score using a neural network-based model trained to evaluate likeness based on identity-preserving features.

19. A system for identifying and removing unauthorized digital likenesses, comprising a user interface configured to receive a report of suspected unauthorized content; a biometric capture module configured to collect real-time facial video and/or voice audio from a reporting user; an identity verification module configured to validate a government-issued identification document submitted by the reporting user; an AI similarity engine configured to compare the biometric data of the reporting user to the reported content and generate a similarity score; a takedown module configured to initiate removal of the reported content from a digital platform if the similarity score exceeds a predefined threshold; and a counterclaim interface configured to receive biometric data and identification from a content uploader and to re-evaluate the reported content based on the uploader's submitted data.

20. A non-transitory computer-readable medium storing instructions that, when executed by one or more processors, cause the processors to perform the method of claim 1.

21. The method of claim 1, wherein the real-time biometric scan is performed across two user devices, the first device configured to capture biometric data including facial, body, or voice input, and the second device configured to capture biometric data including facial, body, or voice input, wherein the devices are paired and synchronized via a secure connection to jointly submit biometric inputs for similarity evaluation.
